(19) United States
(12) Patent Application Publication
(10) Pub. No.: US 2003/0103233 A1
(43) Pub. Date: Jun. 5, 2003

(54) Methods and apparatus for retrieving information for imaging apparatus

(76) Inventor: Christian Struble, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/002,004

(22) Filed: Dec. 5, 2001

(51) Int. Cl. B41J 1/00; G06F 15/00; H04N 1/00

(52) U.S. Cl. 358/1.15; 358/402

(57) ABSTRACT

A system to retrieve information pertaining to an imaging apparatus. The system includes an imaging apparatus having an information retrieval signal generator configured to generate an information retrieval signal. The system further includes a communication device connectable to an information network. The system has a processor configured to execute a series of computer executable instructions, and a memory device containing an information retrieval program. The information retrieval program includes a series of computer executable instructions to detect the information retrieval signal. In response to detecting the information retrieval signal, the information retrieval program directs the controller to retrieve from the information network, via the communication device, information pertaining to the imaging apparatus.

### FIELD OF THE INVENTION

The invention claimed and disclosed herein pertains to imaging apparatus, and more particularly to methods and apparatus for accessing and retrieving current information applicable to an imaging apparatus.

### BACKGROUND OF THE INVENTION

The present invention pertains to methods and apparatus for accessing and retrieving current information applicable to an imaging apparatus. By “imaging apparatus” I mean any apparatus which is configured to generate an image on a sheet of media (such as paper or a transparency, for example). “Imaging apparatus” include computer printers (such as a laser printer or an ink-jet printer), as well as photocopiers, facsimile machines, and so-called “all-in-one” or “multi-function” imaging apparatus which incorporate attributes of one or more of other imaging apparatus. For example, many imaging apparatus are configured to function as a printer to print an imaged sheet of media from an electronic file, as well as to generate a copy of a previously imaged sheet of media.

Frequently a user of an imaging apparatus desires to obtain information applicable to the imaging apparatus. Such information can include: information regarding trouble-shooting of problems with the imaging apparatus (such as, what to do if color registration is not correctly aligned in a multi-color imaging apparatus, the causes of frequent paper jams, and what to do when a network-configured imaging apparatus will not print certain print jobs submitted via the network); where to obtain replacement parts for the imaging apparatus; how to replace components in the imaging apparatus; where to send the imaging apparatus for off-site servicing; the entity to be contacted for on-site servicing; and where to send components (or the imaging apparatus itself) for recycling when the component or imaging apparatus is no longer of use.

Past practice has been to provide the bulk of this information to the user along with the imaging apparatus itself (either as literature in the way of a printed user's manual or pamphlets, via a computer readable “help” file, or some combination thereof). There are several drawbacks to this prior art method of providing information to the user. First, the user may misplace or lose the literature. Second, the information originally provided to the user can change. For example, if the address to which an imaging apparatus is to be sent for servicing changes, then the user will not necessarily know (or remember) this. Likewise, the literature originally provided with the imaging apparatus can contain errors, or the literature can be incomplete. Typically the manufacturer of an imaging apparatus will correct the literature once the manufacturer becomes aware of errors or omissions in the literature, and the corrected literature will be included in future shipments of the imaging apparatus. However, for imaging apparatus which have already been distributed to end users, it can be very difficult (and virtually impossible in some instances) to locate the end user and provide them with the corrected literature.

One solution to this problem is to make the most recent information pertaining to the imaging apparatus available to the user via an information service, such as via a web site on the Internet. While this allows the most recent information to be made available to the user, it also requires the user to search for the information. It also requires a certain skill level on the part of the user, which the user may not possess.

Another situation in which it is desirable to provide information to a user pertaining to an imaging apparatus is where the user may not be aware that the need for such information exists. For example, a product service recall may be issued by the manufacturer to address a defect in the product. While product registration can help the manufacturer to locate users of the product, if the user has moved, or the product has been resold, then it becomes very difficult for the manufacturer to locate users of the product and inform them of the recall. Further, many components of imaging apparatus are designed to have a specific design life. For example, media feed rollers, fusing units, transfer belts, photoconductors, print heads, gear trains, and other components which experience wear as a result of use all have a design life. One manner in which a user can determine the useful life of such a component is by using the imaging apparatus until the component fails. However, this is undesirable since (1) failure of the component can deprive the user of the use of the imaging apparatus until the failed component has been replaced, and (2) failure of the component can damage other components within the imaging apparatus. It is thus desirable to be able to notify a user when various components are reaching the end of their design life. The user can then take appropriate steps to perform preventative maintenance (by replacing the component prior to failure), or to replace the imaging apparatus when it appears the apparatus is nearing the end of its economically useful life.

Yet another situation in which it is desirable to provide information to a user pertaining to an imaging apparatus relates to recycling components of the imaging apparatus, or the imaging apparatus itself. Laws regarding the recycling of spent goods are becoming more commonplace. In some instances, manufacturers are required to manufacture their products such that a certain percent of the content can be recycled. Coupled with these requirements are the requirements that the manufacture ensures that the recyclable content of the product is indeed recycled. One manner in which a manufacturer can comply with this latter obligation is to track its products as the products move through the marketplace, so that the manufacturer can obtain control of the product when it is discarded. However, many product transfers are outside of the control of the manufacturer. For example, if a first user purchases an imaging apparatus and then subsequently sells or gives the apparatus to a second user, the manufacturer of the apparatus will typically be unaware of this second transaction, and will be unable to locate the product. Furthermore, in such an instance the second user may not be provided with information regarding the return of the apparatus, or components thereof, for recycling. Even when a user is aware that a component (for example, a spent toner cartridge) should be recycled, the user may be disinclined to take the necessary steps to recycle the component if the user perceives that a considerable amount of effort may be involved.

What is needed then is a way to enhance access to information pertaining to imaging apparatus, which achieves the benefits to be derived from similar prior art solutions, but which avoids the shortcomings and detriments individually associated therewith.

### SUMMARY OF THE INVENTION

In a first embodiment, the present invention provides for a system to retrieve information pertaining to an imaging apparatus. The system comprises an imaging apparatus comprising an information retrieval signal generator configured to generate an information retrieval signal. The system also includes a communication device connectable to an information network, and a processor configured to execute a series of computer executable instructions. A memory device is included in the system, and the memory device contains an information retrieval program. The information retrieval program comprises a series of computer executable instructions to detect the information retrieval signal and, in response thereto, to retrieve from the information network, via the communication device, information pertaining to the imaging apparatus.

A second embodiment of the present invention provides for an imaging apparatus comprising a user display configured to present to a user a plurality of retrievable information types. Each information type is associated with information pertaining to the imaging apparatus. The imaging apparatus further includes a user input to allow the user to select at least one of the retrievable information types, and to generate an associated information retrieval signal in response thereto. A communication device, connectable to an information network, is also included in the imaging apparatus. The imaging apparatus has a controller configured to receive the information retrieval signal and, in response to receiving the retrieval signal, the controller is configured to use the communication device to retrieve, from the information network, the associated information pertaining to the imaging apparatus.

A third embodiment of the present invention provides for an imaging apparatus comprising a condition detector configured to generate an information retrieval signal in response to a detected condition within the imaging apparatus. The imaging apparatus includes a communication device connectable to an information network, and a controller configured to receive the information retrieval signal. In response to receiving the information retrieval signal, the controller is configured to use the communication device to retrieve, from the information network, information associated with the detected condition.

A fourth embodiment of the present invention provides for a method of retrieving information pertaining to an imaging apparatus. The method includes generating an information retrieval signal, and using the information retrieval signal to initiate a communication session with an information network. During the communication session, information pertaining to the imaging apparatus is retrieved from the information network.

These and other aspects and embodiments of the present invention will now be described in detail with reference to the accompanying drawings, wherein:

### DESCRIPTION OF THE DRAWINGS

FIG. 1 is a schematic diagram depicting a computer network which incorporates imaging apparatus, and a system for retrieving information pertaining to the imaging apparatus, in accordance with embodiments of the present invention.

FIG. 2 is a front elevation schematic diagram depicting an imaging apparatus of FIG. 1, in accordance with an embodiment of the present invention.

FIG. 3 is a schematic diagram depicting an imaging apparatus information retrieval program, in accordance with an embodiment of the present invention.

FIG. 4 is a schematic diagram depicting a series of menus than can be used in the network of FIG. 1, and the imaging apparatus of FIG. 2, and which can be accessed by a user to implement methods of the present invention.

FIG. 5 is a flow chart depicting a series of steps which can be executed to implement one method in accordance with the present invention.

FIG. 6 is another flow chart depicting a series of steps which can be executed to implement another method in accordance with the present invention.

FIG. 7 is a schematic diagram depicting various condition detectors which can be used to detect conditions within an imaging apparatus which require attention.

### DETAILED DESCRIPTION OF THE INVENTION

The present invention provides methods and apparatus for retrieving information pertaining to an imaging apparatus from an information network. Preferably, the information network is maintained with current information to avoid the problems of the prior art, described above. The methods and apparatus of the present invention also simplify the task of retrieving information pertaining to an imaging apparatus, and can also perform the information retrieval automatically in certain instances.

The present invention is applicable to any imaging apparatus, which can include printers (such as electrophotographic printers and inkjet printers, among others), photocopiers, facsimile machines, and combinations thereof. Generally, imaging apparatus include any apparatus which is configured to generate an image on sheet media (such as paper or transparencies) using imaging media (such as ink or toner). Accordingly, although the accompanying figures may depict one specific type of imaging apparatus (such as a printer), it is understood that this is not meant to limit the scope of the present invention to that particular type of imaging apparatus.

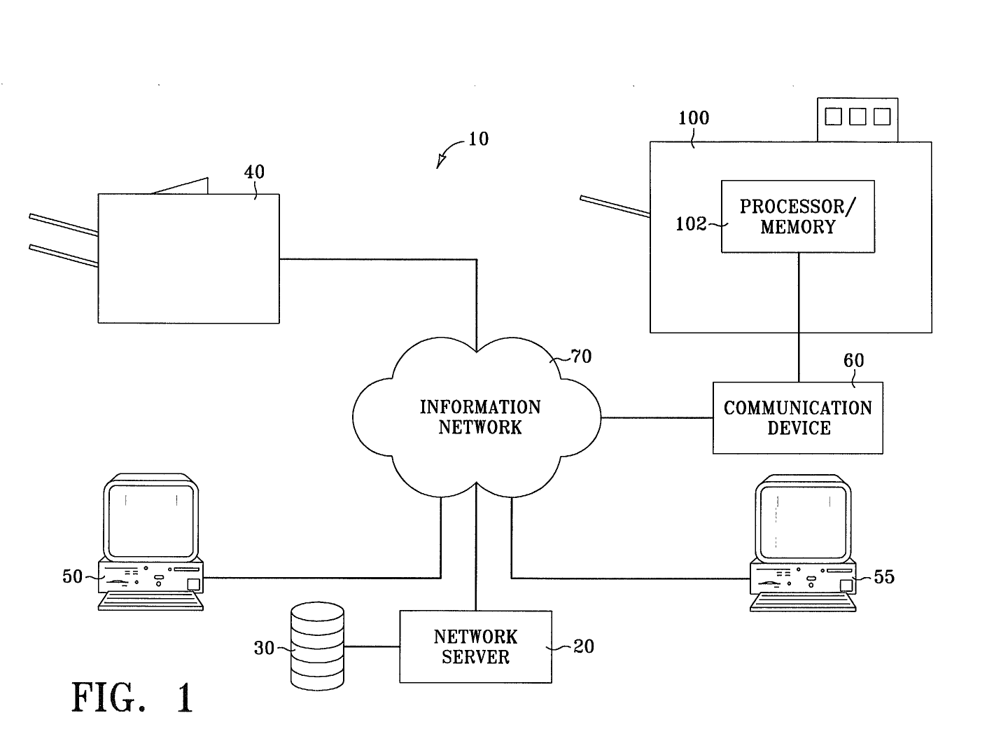

The present invention is applicable to stand-alone or dedicated imaging apparatus (for example, a printer connected to a single personal computer, or a photocopier which is not connected directly to a network). The invention is further applicable to imaging apparatus which comprise part of a network. An example of the latter configuration is depicted in the schematic diagram of FIG. 1, which shows a first imaging apparatus 100 in a computer network 10. As depicted, the network 10 includes a plurality of workstations or personal computers 50 and 55, a second imaging apparatus 40, a network server 20, as well as a memory device 30 which can be used to store applications programs as well as data, all of which are connected to an information network 70. In this configuration, a user can send a print job from workstation 50 or 55 to either imaging apparatus 40 or 100.

It will be appreciated that alternate configurations of FIG. 1 can be provided, to similar effect. For example, the network server 20 can be placed in the central position occupied by the information network of FIG. 1, in which case the information network 70 can be connected directly to the network server 20. Further, when the network server 20 is in the central position which is shown as being occupied by the information network 70 of FIG. 1, then the information network can be connected directly to the communication device 60, or to one of the workstations 50 or 55.

As depicted in FIG. 1, imaging apparatus 100 includes a processor and memory device (shown in combination as 102) which is connected to a communication device 60. Although the communication device 60 is shown as being connected directly to the processor 102 of the imaging apparatus 100, the communication device 60 can also be connected to the network server 20, or to one of the workstations 50 or 55, in which case the imaging apparatus 100 can be connected directly to the information network 70. When the communication device 60 is connected directly to one of the workstations 50 or 55, then the communication device 60 can be accessed by the processor 102 via the server 20, via the information network 70, or via directly one of the workstations 50 or 55. The communication device 60 is configured to be connectable to an information network 70. The communication device 60 can be one or more of any known device for connecting a processor (which can process received information) to an information network. Examples of such communication devices include modems (such as a twisted-pair (common telephone wire) modem, a digital subscribe line (“DSL”) modem, a cellular (telephone) modem, a satellite modem, and a cable modem), and an Ethernet interface card. The communication device 60 can also be a web server such that the imaging apparatus 100 is provided with its own web address so that information can be provided from the imaging apparatus 100 to other devices in communication with the information network 70.

Although the information network 70 can be a restricted network, preferably the information network 70 is an unrestricted global information network, such as the Internet, and more preferably the information network 70 is the World Wide Web. The information network 70 can also consist of a combination of one or more restricted networks and the Internet or World Wide Web. The use of an essentially unrestricted network (i.e., a network that can be accessed by any user, although a password or an account may be required) allows third party users of an imaging apparatus to retrieve information pertaining to the imaging apparatus from the manufacturer of the apparatus, or from an authorized service provider. In this way, there is no burden placed on the user of the imaging apparatus to maintain the information in the information network 70. That is, the user can have an expectation that, since the information pertaining to the imaging apparatus has been placed on the information network 70 by an authorized entity, the information is reasonably current and accurate.

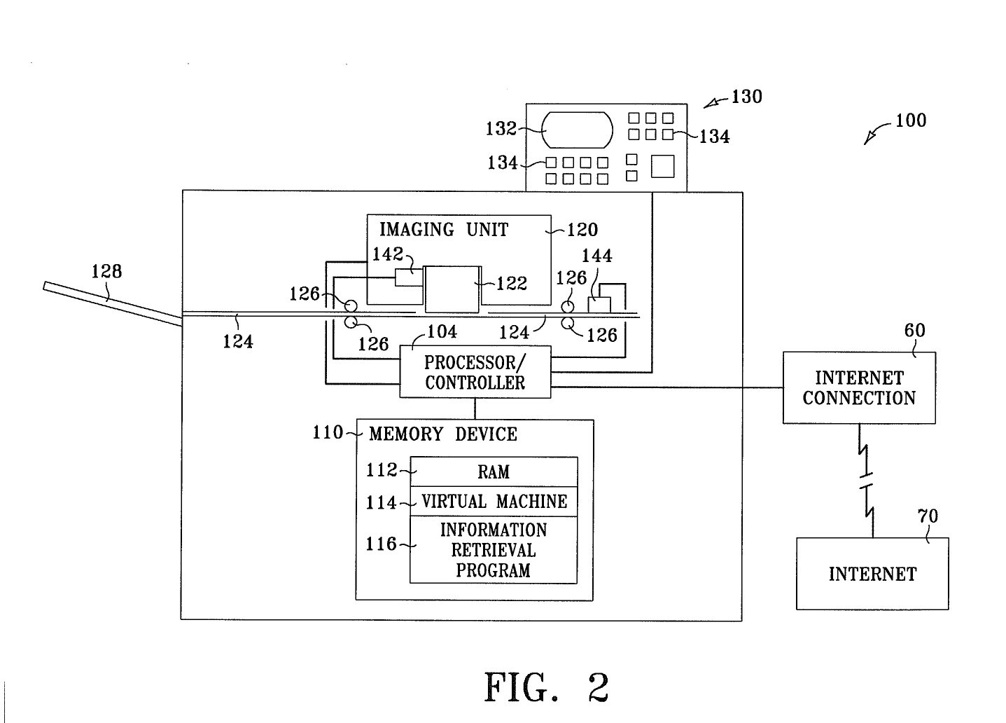

Turning to FIG. 2, a front elevation schematic diagram depicting the imaging apparatus 100 of FIG. 1 is shown in more detail. The imaging apparatus 100 is configured to feed sheet media (not shown) from a sheet media supply (not shown) into the right side of media path 124. Feed rollers 126 move sheet media along the media path past an imaging unit 120 which produces an image on the sheet media. An imaging media container 122 (such as a toner cartridge or an ink reservoir) transfers imaging media (either directly or indirectly) to the sheet media, and the imaged sheet media is then placed in the media output tray 128. The imaging apparatus 100 includes a processor (or controller) 104 which is used to control the operation of the imaging unit 120, as well as the information retrieval system of the present invention, as will be described more fully below. The imaging apparatus further includes a user interface 130, which comprises a user display 132 and user input points (such as keys or buttons 134), which I will term a “user input device”. The user display 132 can be, for example, a liquid crystal display screen. Both the user display 132 and the user input device 134 can be used to assist a user in selecting the type of information pertaining to the imaging apparatus which the user desires to retrieve. Further, the user display device 132 can be used to display retrieved information to the user. The user interface 130 can also include a touch-screen (not shown) which acts as a combination user display and user input device. By accessing the user input device 134, a user can generate an information retrieval signal which can be used by the controller 104 to retrieve, from the information network 70, information pertaining to the imaging apparatus 100. A fuller description of the use of the user interface 130 is provided below.

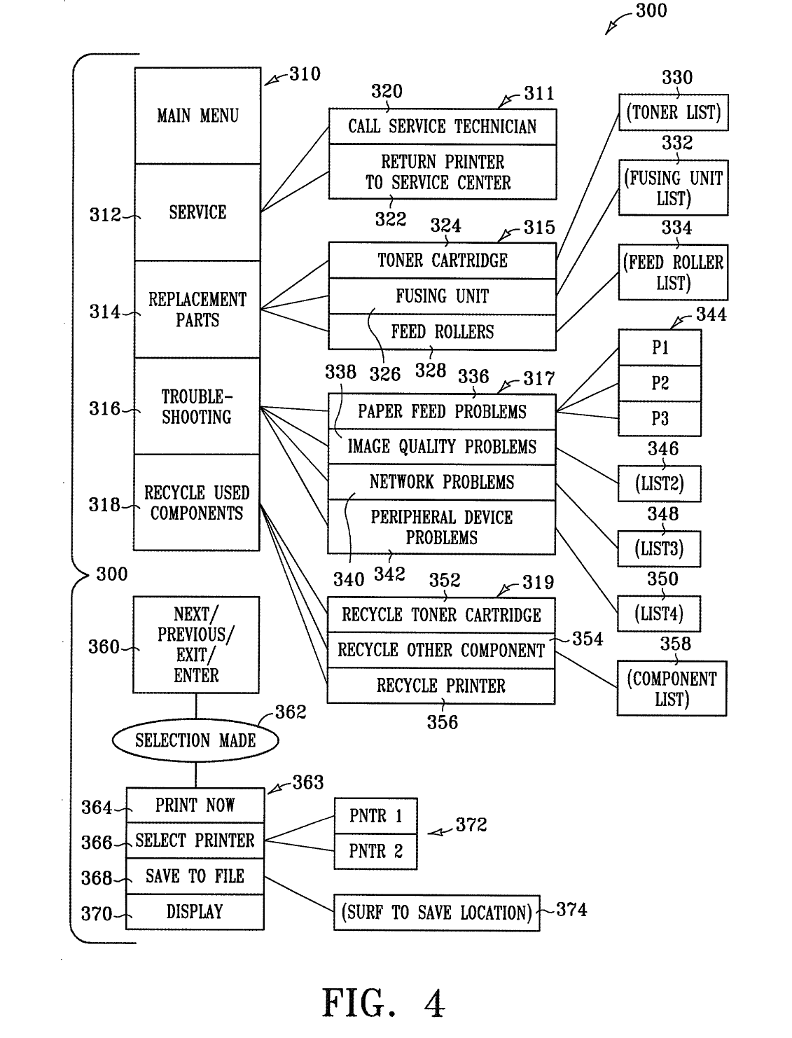

Turning to FIG. 4, a schematic diagram 300 depicts an exemplary series of menus that can be presented to a user via a graphical display (such as user display 132 of FIG. 2) to allow a user to retrieve information pertaining to an imaging apparatus, such as imaging apparatus 100 (FIG. 2). The menus depicted in FIG. 4 are layered, and allow the user to select a particular topic (“information type”) for which information is to be retrieved from the information network (70 of FIG. 2). The menu system 300 includes at a first, highest, level the Main Menu 310. The main menu 310 can include such information categories as “Service” 312, “Replacement Parts” 314, “Trouble Shooting” 316, and “Recycle Used Components” 318. By selecting “Service” 312, the user is presented with a secondary menu 311 which allows the user to select either “Call Service Technician” 320 or “Return Printer To Service Center” 322. By selecting “Call Service Technician” 320, an information retrieval signal is generated, which is used to cause the controller 104 (FIG. 2) to use the communication device 60 to retrieve from the information network 70 information pertaining to having a service technician arrive at the site of the imaging apparatus to service the apparatus. This information can include the phone number for arranging a service call. Further, the user can have a service agreement for servicing the imaging apparatus, and the retrieved information can include an account number as well as other information required by the user to arrange for a service call. Alternately, by selecting “Return Printer To Service Center” 322, the information retrieved from the information network can include information for packaging the imaging apparatus for return to a service center, a service request form to be completed by the user, and a shipping label the user can use to return the imaging apparatus.

When the user selects “Replacement Parts” 314 from the Main Menu 310 of FIG. 4, the secondary menu 315 can be displayed, which presents the user with the selections “Toner Cartridge” 324, “Fusing Unit” 326, and “Feed Rollers” 328. Each of these secondary menu choices can be associated with tertiary menus. For example, by selecting “Toner Cartridge” 324, a list “Toner List” 330 can be displayed to the user. In the case of a color imaging apparatus, the Toner List 330 can include four different toner cartridges (black, yellow, cyan and magenta). By selecting the desired toner cartridge, the retrieved information can include reorder information for a replacement toner cartridge, as well as information for recycling the spent cartridge. (A similar menu selection can be applied for ink cartridges when the imaging media is ink.) When the imaging apparatus is a monochrome imaging apparatus, then the tertiary menu 330 is not necessary. Likewise, when the imaging apparatus uses more than one type of fusing unit (as can occur in a color imaging apparatus), by selecting “Fusing Unit” 326, a “Fusing Unit List” 332 of fusing units can be presented to the user. The user can then retrieve ordering information for the desired replacement fusing unit. Similarly, by selecting “Feed Rollers” 328, a “Feed Roller List” 334 of the different types of feed rollers can be displayed (for example, paper tray pick roller, media path feed rollers, and duplex unit feed rollers). The user can then retrieve ordering information for the desired replacement feed roller.

By selecting “Trouble-Shooting” 316 from the Main Menu 310, the secondary menu 317 is presented to the user, which contains the options “Paper Feed Problems” 336, “Image Quality Problems” 338, “Network Problems” 340, and “Peripheral Device Problems” 342. Each of these selections is further associated with a tertiary list of potential problems. For example, selecting “Paper Feed Problems” 338 displays a list 344 of three different paper feed problems P1, P2 and P3. Problem P1 can be “Paper will not feed from feed tray”, problem P2 can be “Paper jams in printer at fusing station”, and so on. By selecting one of the offered problems from the list 344, information is retrieved from the information network (70, FIG. 2) which can include possible causes for the problem and recommended solutions to the problem. Likewise, “List2” 246 which is associated with “Image Quality Problems” 338 can be used to retrieve information related to specific image quality problems (for example, color registration, image fade, etc.), including the possible causes of the problem and recommended solutions. Similarly, the “Network Problems” selection 340 has an associated list 348 (“List3”) of possible problems (e.g., “Print job won't print from a workstation on the network”, “Workstation on the network does not recognize printer”, and so on). The list 350 (List 4) associated with the “Peripheral Device Problems” selection 342 can address problems associated with peripheral devices connected to the imaging apparatus. Such peripheral devices can include, for example, a duplex (2-sided) sheet feeder, a finishing device (stapler, sheet folder, booklet making unit, etc.) and an envelope feeder. The list 350 associated with “Peripheral Device Problems” 342 can include such items as, “Duplex unit does not work”, “Stapling unit does not work”, and so on. As with the other final level selections previously described (344, 346 and 348), making a selection from the list 350 can retrieve information from the information network 70 (FIG. 2) regarding possible problems and solutions for the selected peripheral device problem.

When a user selects the “Recycle Used Components” 318 selection from the Main Menu 310, the secondary menu 319 is displayed, showing options for “Recycle Toner Cartridge” 352, “Recycle Other Component” 354, and “Recycle Printer” 356. It is noted that only “Recycle Other Component” 354 has a tertiary list 358 (“Component List”) associated with the secondary menu 319. The Component List 358 can include such recyclable items as removable paper trays, fusing units, and peripheral devices. Thus, selecting “Recycle Toner Cartridge” 352 or “Recycle Printer” 356 will cause the controller 104 (FIG. 2) to immediately retrieve information regarding how to recycle the indicated item, while making a selection from the Component List 358 will have the same effect with regards to the component selected from the list 358.

The Main Menu 310 (as well as each of the secondary and tertiary menus) can also include a navigation selection 360 allowing the user to move forward (“Next”) and backward (“Previous”) through the various layers of menus. The navigation selection 360 can also include an “Exit” option to allow the user to leave the information retrieval menu system 300, as well as an “Enter” option to enable the information retrieval request. That is, rather than automatically retrieving the selected information when the user makes a final menu selection, the “Enter” option allows the user to make a final decision regarding whether to retrieve the information.

Once the user makes an information retrieval request (indicated by operational step 362), an information delivery menu 363 can be presented to the user. The information delivery menu 363 can include such selectable options as “Print Now” 364, “Select Printer” 366, “Save to File” 368, and “Display” 370. Each of these options allows the user to designate where the retrieved information should be directed. For example, selection “Print Now” 364 will cause the controller 104 (FIG. 2) to print the retrieved information using the imaging apparatus from which the information retrieval request was submitted. Selecting “Select Printer” 366 will cause a list 372 of available printers (in a network having more than one imaging device connected thereto) to be displayed, and the user can then select the printer to be used to print the retrieved information. This can be a useful feature when the imaging apparatus from which the information retrieval request was submitted (e.g., “PNTR 1”) is not capable of printing the information (for example, if the printer engine is broken). In this case, the user can select that the information be printed using “PNTR 2” (e.g., imaging apparatus 40, FIG. 1), in which case the retrieved information will be routed from the communication device (60, FIG. 1) via the information network (70, FIG. 1) to the imaging apparatus 40 (FIG. 1).

Rather than print the retrieved information, the user can also specify that the information be saved to computer readable memory using selection 368, in which event the user display can present to the user a “Surf to Save Location” option 374 allowing a user to navigate to a specified memory location (e.g., memory device, directory, folder, and file name) where the information is to be stored. The memory location can be on the imaging apparatus 100, or in another network location such as workstations 50 and 55, network server 20, or memory device 30. Alternately, the user can select the “Display” option 370 to cause the retrieved information to be displayed using a user display device (such as user display 132 of FIG. 2, or on a display connected to one of the workstations 50 and 55 in the network of FIG. 1).

It is understood that the menu selection 300 depicted in FIG. 4 is exemplary only, and that additional, fewer, or different menu options can be provided, and that the menu system 300 can be configured differently for displaying information-types to be retrieved by the user.

Returning to FIG. 2, the imaging apparatus 100 can also include condition detectors which are configured to generate an information retrieval signal in response to a detected condition within the imaging apparatus. The information retrieval signal is used by the controller 104 to retrieve information from the information network 70, as will be explained further below. In this way, when a predetermined condition is detected within the imaging apparatus, information related to the detected condition can be automatically retrieved from the information network 70 without requiring user intervention. Two types of condition detectors are depicted in FIG. 2. The first condition detector is an imaging media detector 142 which is configured to detect (or estimate) the volume of imaging media (such as toner or ink) remaining in the imaging media container 122. The imaging media detector can thus be used to generate an information retrieval request for ordering a replacement container of imaging media, as well as recycling the spent imaging media container. The second condition detector is a sheet media counter 144. The sheet media counter 144 can be used to count the total number of sheets imaged by the imaging apparatus 100 over a period of time. This condition is indicative of wear on the feed rollers 126, as well as other components within the imaging apparatus (for example, a fuser which is used to fuse imaging media comprising toner to the sheet media).

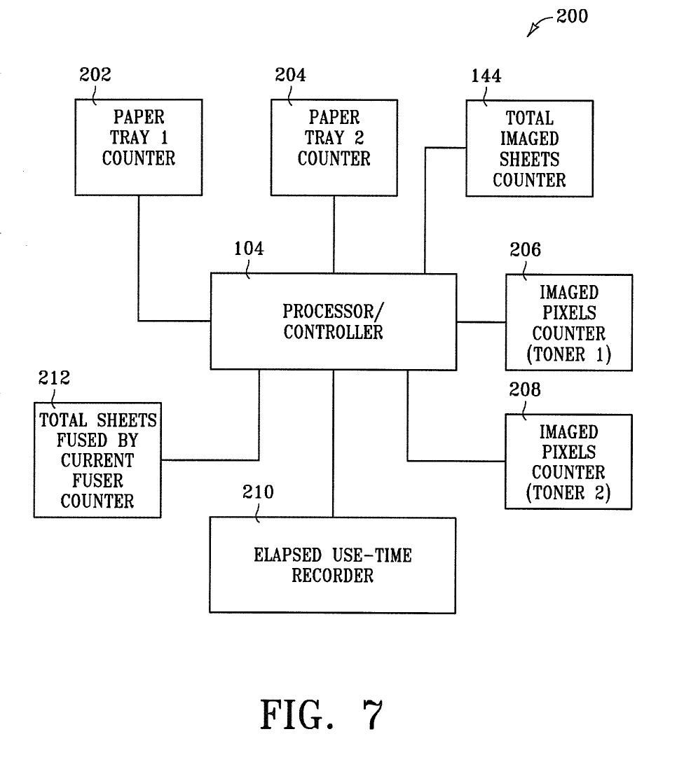

Turning to FIG. 7, a schematic diagram 200 depicts other types of condition detectors which can be used in the imaging apparatus 100 of FIG. 2. Each condition detector is preferably configured to generate a unique information retrieval signal in response to an associated detected condition within an imaging apparatus, such as apparatus 100 of FIG. 2. The controller 104 (FIGS. 2 and 7) is preferably configured to receive the unique information retrieval signal and, in response thereto, to use the communication device (60, FIG. 2) to retrieve from the information network (70, FIG. 2) the information associated with the associated detected condition. As can be seen in FIG. 7, all of the condition detectors are in signal communication with the processor 104. The condition detector 144 of FIG. 2 is shown as a “Total Imaged Sheets Counter” in FIG. 7. In general, the condition detectors comprise sensors which are configured to detect the indicated condition. For example, the sheet counter 144 of FIG. 2 can use an optical switch which is activated by the presence or absence of a sheet of media in the media paper path (124, FIG. 2). Each time the switch is activated, a pulse is generated which corresponds to one sheet of media passing through the imaging apparatus.

Condition detectors 202 and 204 of FIG. 7 are respectively “Paper Tray 1 Counter” and “Paper Tray 2 Counter”. The “paper” (sheet media) tray counters 202 and 204 can be configured to count the total number of sheets of sheet media which are fed from respective first and second media trays over a period of time. For example, the first media tray can be configured to hold letter sized sheet media, and the second media tray can be configured to hold legal sized sheet media. Counting the number of sheets of sheet media fed from each tray is indicative of wear on pick rollers which are used to pick the top sheet of media from the respective tray and feed it into the media path 124 (FIG. 2). Thus, when the controller (104, FIG. 2) determines that a preselected number of sheets of media have been fed from a particular media tray, the controller 104 can be caused to retrieve information from the information network 70 recommending replacement of the pick rollers associated with that media tray, which can include part numbers for replacement pick rollers, ordering information, instructions for replacement, and information on how to have the pick rollers replaced if the user does not wish to effect such repairs himself.

FIG. 7 also depicts condition detectors 206 and 208 which are respectively “Imaged Pixels Counter (Toner 1)” and “Imaged Pixels Counter (Toner 2)”. A pixel counter is configured to detect (or approximate) the total number of pixels of a given toner which the imaging apparatus has imaged over a predetermined period of time. This information is indicative of the wear on certain components within the imaging apparatus, such as a fuser and an optical photoconductor in an electrophotographic imaging apparatus, and a print head in an ink jet imaging apparatus. An example where two pixel counters 206 and 208 can be employed is in a color imaging apparatus where more than one imaging media (for example, black and red toner or ink) is used. In a monochrome imaging apparatus (e.g., a black-and-white printer) only one such pixel counter is required to count (or estimate) the imaged pixels. The information retrieval signal generated by the pixel counter condition detectors 206 and 208 can be used to retrieve information from the information network 70 (FIG. 2) regarding: recommended replacement of components related to total pixels imaged; ordering and installation of replacement parts; and/or having the imaging apparatus serviced to replace the worn components.

Yet another condition detector depicted in FIG. 7 is the “Total Sheets Fused By Current Fuser Counter” 212. As the name suggests, the sheets-fused condition detector 212 is configured to count the number of sheets which have been fused using the presently installed fuser. This information is indicative of the wear on a fuser and an optical photoconductor in an electrophotographic imaging apparatus.

The imaging apparatus 100 (FIG. 2) can also include an “Elapsed Use-Time Recorder” condition detector 210 (FIG. 7), which measures (detects) the total elapsed time that the imaging apparatus has actually been functionally operating to image sheet media. This information is indicative of overall wear on components within the imaging apparatus which are generally not considered to be replaced as a matter of course. For example, feed rollers and optical photoconductors are generally considered to have a useful life which is shorter than other components within the imaging apparatus, such as gear trains, motors, and switches. Accordingly, a manufacturer may select a predetermined period of time after which these latter components might begin to fail. At this time, the elapsed-use condition detector 210 can generate an information retrieval signal which can be used by the controller 104 to retrieve information from the information network (70, FIG. 2) advising the user that the imaging apparatus is approaching its design life, and that replacement of the imaging apparatus is advisable. The retrieved information can also include information on recycling the old imaging apparatus, as well as information on ordering a compatible replacement imaging apparatus.

It is understood that the condition detectors depicted in FIGS. 2 and 7 are exemplary only, and that other types of condition detectors can be used in imaging apparatus in accordance with the present invention. For example, in addition to (or alternate to) tracking conditions within the imaging apparatus for recommended replacement of components, the condition detectors can also be configured to detect the failure or malfunction of components within the imaging apparatus. In this event, the information retrieval signal generated by the condition detector can be used to retrieve information pertaining to the presence of the condition, and also to inform the user how repairs should be effected.

As can be seen, both the user interface 130 of FIG. 2, and the condition detectors (142 and 144 (FIG. 2), and 202, 204, 206, 208, 210 and 212 (FIG. 7)) can be used to generate information retrieval signals. Accordingly, both the user interface and the condition detectors can be considered as “information signal generators”. The user interface (user input device) can be used to manually generate information retrieval signals, and the condition detectors can be used to automatically generate information retrieval signals. The present invention allows for either type of information signal generator to be employed in an imaging apparatus, as well as for both types of information signal generators to be employed together.

The controller 104 of the imaging apparatus 100 of FIG. 2 is in signal communication with the communication device 60, as described above with respect to FIG. 1. The communication device 60 is connectable to the information network 70, as also described above. Although the communication device 60 is depicted as being outside of the imaging apparatus 100 in FIGS. 1 and 2, it can also be located inside the imaging apparatus. The imaging apparatus 100 further includes a memory device 110 which is in communication with the controller 104. Although the memory device 110 is depicted as being a single unit, it can be a combination of different memory device units. For example, the memory device 110 can collectively (or separately) comprise a magnetic disk (such as a hard drive), an optical disk, semiconductor chips (in the form of read-only-memory (ROM) and/or random-access-memory (“RAM”), and other devices configured to store digital information in a retrievable format. The memory device 110 preferably includes at least a RAM portion 112 to allow information (such as information retrieved from the information network 70) to be temporarily stored.

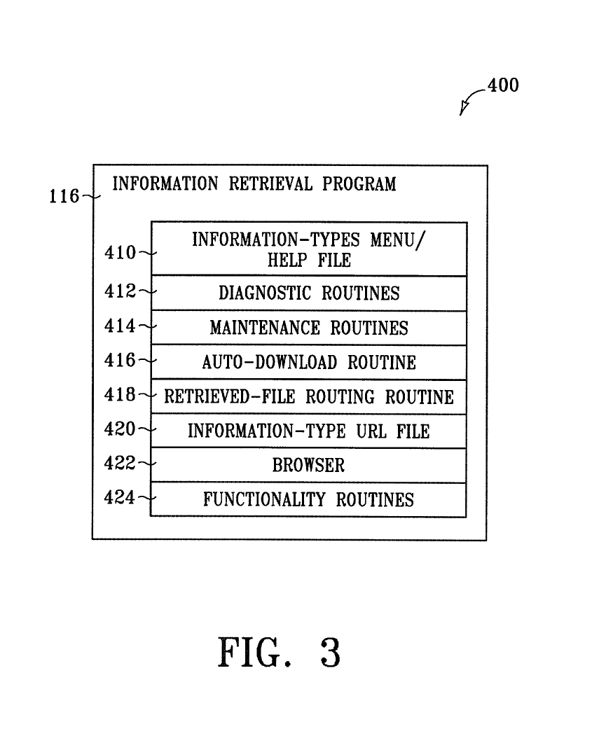

The memory device 110 can also be used to store a series of computer executable instructions (a “program”) which are configured to be executed by the processor 104. Specifically, the memory device 110 can contain an “information retrieval program” 116 which can be used to retrieve information pertaining to the imaging apparatus 100 from the information network 70. The information retrieval program 116 can include software used to communicate with the information network 70. For example, when the information network 70 is the Internet, the information retrieval program 116 can include a network browser, such as “Internet Explorer”, available from Microsoft Corp. of Redmond, Wash. Turning to FIG. 3, a schematic diagram 400 depicts various components which can be included in the information retrieval program 116. The information retrieval program 116 can include a file 410 of information-types, which can be presented to a user as described above with respect to FIG. 4. File 410 can also include a “Help” file which can be displayed to a user (e.g., via user display 132 of FIG. 2) to assist a user in using the information retrieval system of the present invention. The program 116 can also include diagnostic routines 412 which can be performed by the controller to diagnose problems within the imaging apparatus (100, FIG. 2). Based on the results of the diagnosis, the program 116 can execute an auto-download routine 416 to automatically retrieve information related to the diagnosed problem, similar to the manner in which condition detectors (described above) can be used to automatically retrieve information related to the detected condition.

The information retrieval program 116 (FIG. 3) can also include maintenance routines 414. The maintenance routines are configured to operate in conjunction with condition detectors to automatically generate information retrieval requests based on recommended preventative maintenance for the imaging apparatus, as described above with respect to FIG. 7. As with the diagnostic routines 412, the maintenance routines 414 can use the auto-download routine 416 to cause the communication device (60, FIG. 2) to automatically retrieve the designated information from the information network (70, FIG. 2).

The program 116 of FIG. 3 can further include a “retrieved-file routing routine” 416, which essentially implements the information delivery menu system (363, FIG. 4), and can also automatically make determinations of where to send the retrieved information based on previously established criteria. For example, the default delivery location can be to print the retrieved information using the imaging apparatus from which the information request was generated. If the default imaging apparatus is unavailable (broken, for example), then, when a second imaging apparatus is available on a network to which the first (default) imaging apparatus is connected (e.g., network 10 of FIG. 1), the retrieved information can be printed using the second imaging apparatus (e.g., imaging apparatus 40 of FIG. 1). Alternately, if a second imaging apparatus does not exist (or is unavailable), the information can be displayed on a user display (e.g., display 132 of FIG. 2), or stored to a default memory location (for example, in memory device 110 of FIG. 2) so that the retrieved information can be recalled later and printed or viewed.

When the information network (70, FIG. 2) is the Internet, then the information retrieval program 116 (FIG. 3) can include a browser 422, as described above. In this instance, the information retrieval program 116 can further include an “information-type URL” file 420. A “URL” is a “Universal Resource Locator”, which functions as the address of a web page on the World Wide Web of the Internet. The URL file 420 can contain a plurality of universal resource locators (URLs), and each of the plurality of retrievable information types (as exemplarily depicted in FIG. 4) has an associated one of the URLs. For example, if the information type to be retrieved is the information pertaining to recycling of a spent toner cartridge (selection 352, FIG. 4), then the information retrieval signal generated by making that selection causes the information retrieval program 116 to find the URL associated with selection 352. The controller 104 (FIG. 3) then uses the browser 422, via the communication device (60, FIG. 2) to go to the associated URL address on the Internet (70, FIG. 2) and retrieve the information pertain to recycling of a spent toner cartridge.

In addition to the specific routines and files described above with respect to the information retrieval program 116 (FIG. 3), the program 116 also includes functionality routines 424, which are those executable instructions required to provide full functionality to the program 116 in performing the information retrieval methods of the present invention.

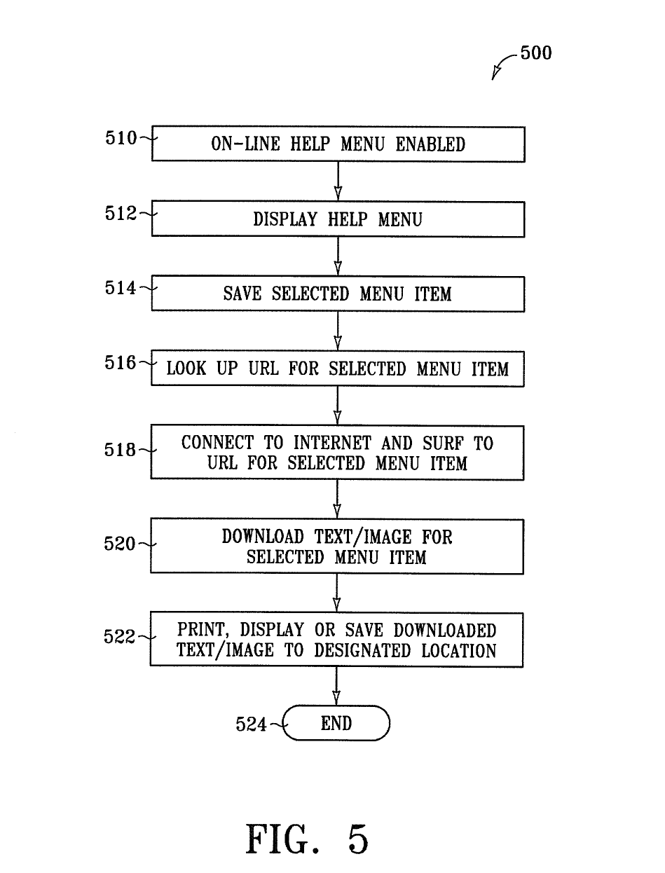

Turning now to FIG. 5, a flow chart 500 depicts a series of steps that can be implemented as selected executable steps of the information retrieval program 116 of FIGS. 2 and 3. The flow chart 500 of FIG. 5 basically conforms to the user-accessible menu system 300 of FIG. 4. In this case, information retrieval signals are generated by a user using a user input device (e.g., user interface 130 of FIG. 2). Thus, at step 510 of the flow chart 500 the on-line help menu (e.g., Main Menu 310, FIG. 4) is enabled. This can be accomplished when the user selects “On-line help” or the like from a keypad or a general menu on the imaging apparatus (100, FIG. 2). At step 512, the help menu (Main Menu 310, FIG. 4, for example) is displayed to the user (e.g., via user display 132, FIG. 2). The user then selects an information-type pertaining to imaging apparatus information the user wishes to retrieve from the information network (70, FIG. 2). At step 514 the processor (104, FIG. 2) saves the selected menu item in the memory device (110, FIG. 2). At step 516 the information retrieval program 116 (FIGS. 2 and 3) then causes the processor 104 to “look up” the URL which is associated with the selected menu item (e.g., from the information-type URL file 420 of FIG. 3). At step 518 the controller causes the communication device (60, FIG. 2) to connect to the Internet (70, FIG. 2) and “surf” to the URL for the selected menu item. This can be accomplished using the browser 422 of FIG. 3. At step 520 the requested information, in the form of text and/or images, is downloaded from the Internet via the communication device (60, FIG. 2), and at step 522 the controller 104 can selectively print, display or save to memory the downloaded information (or any combination thereof. The process then ends at step 524.

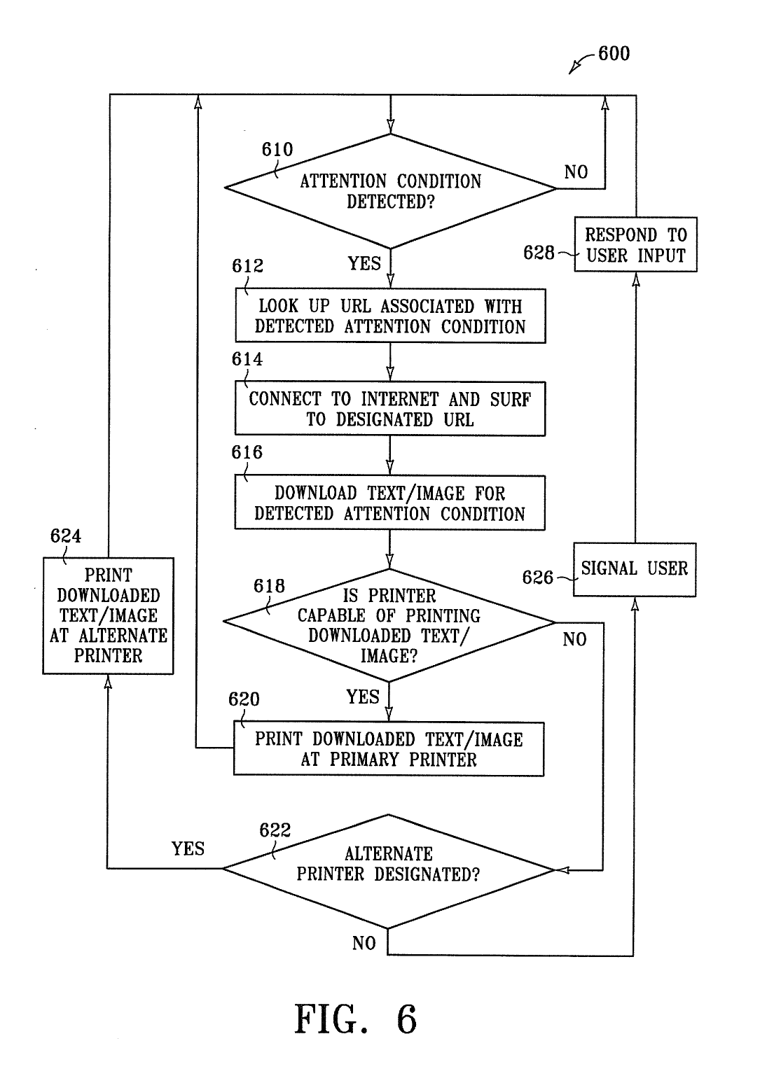

Turning to FIG. 6, another flow chart 600 is depicted which can also comprise a series of steps that can be implemented as selected executable steps of the information retrieval program 116 of FIGS. 2 and 3. The flow chart 600 of FIG. 6 basically conforms to the condition detector system 200 of FIG. 7. In this case, information retrieval signals are automatically generated by the condition detectors in response to detecting a predefined condition or event within the imaging apparatus. At step 610 of the flow chart 600 the controller polls the condition detectors to determine whether an “attention condition” has been detected. An “attention condition” is a condition which is to be brought to the attention of the user. An attention condition can correspond to a malfunction in the imaging apparatus, or merely a recommended service interval for selected components of the imaging apparatus. If no attention condition is detected, the controller continues to poll the condition detectors at step 610. However, if an attention condition is detected, then at step 612 the controller looks-up the URL (from the URL list 420 of FIG. 3, for example) which corresponds to the detected condition. Then, at step 614, the controller connects to the Internet (70, FIG. 2, via the communication device 60 of FIG. 2) and “surfs” to the designated URL. For example, if the detected condition is “low toner” (which can be detected by the imaging media (i.e., toner) detector 142 of FIG. 2), then the URL will cause the browser 422, FIG. 3) to go to a web site which contains information pertaining to ordering a replacement toner cartridge, and recycling the spent toner cartridge. At step 616 of the flowchart 600 the relevant information (in the form of text and/or images) is downloaded from the Internet to the controller 104 (FIG. 2).

The balance of the flow chart 600 (following step 616) is dedicated to a “retrieved-file routing routine” such as routine 418 of FIG. 3, which was generally described above. Thus, at step 618 the controller (104, FIG. 2) checks to determine whether the imaging apparatus from which the information request was generated is capable of printing the retrieved information. If so, at step 620 the downloaded file (i.e., the retrieved information) is printed using the default printer, and the controller 104 (FIG. 2) is then directed to continue polling for an attention condition at step 610. However, if at step 618 the primary printer (imaging apparatus) cannot print the retrieved information, then at step 622 the controller 104 (FIG. 2) checks to determine whether an alternate printer has been designated (such as imaging apparatus 40 of FIG. 1). If so, at step 624 the retrieved information is printed using the alternate printer, and the controller is then directed to continuing polling for an attention condition at step 610. However, if no alternate printer is designated at step 622, then at step 626 the user is signaled (for example, via the user display 132, FIG. 2). The user can then respond at step 628 (for example, by viewing the information on a display, or saving the information in a memory device), and thereafter the controller 104 (FIG. 2) is directed to continuing polling for an attention condition at step 610.

It is understood that the flow charts 500 (FIG. 5) and 600 (FIG. 6) are exemplary only, and that additional or different steps can be employed to accomplish the methods of the present invention.

Returning to FIG. 2, the memory device 110 can further include a “virtual machine” 114 which can operate in conjunction with the information retrieval program 116. A “virtual machine” is essentially a program that allows the controller 104 to execute instructions in a protected memory space separate from the main functions of the imaging apparatus. One example of a virtual machine is a Java Virtual Machine (“JVM”) which runs instructions compiled in the Java programming language. The information retrieval program 116 could thus be implemented as a Java program running inside the memory space of JVM 114.

The JVM provides enhanced functionality to the information retrieval system, by providing additional security, and by allowing the link between the imaging apparatus 100 and the information network 70 to be dynamic. For example, part of the information retrieval program 116 can be designed to process instructions sent by the information network 70.

For example, if a user submits an information request pertaining to an image quality problem (see selections 338 and 346, FIG. 4), then, in response to the information retrieval request, the information network 70 can send a request (in the form of an XML, or “extensible Markup Language” document, for example) back to the imaging apparatus 100, requesting the controller 104 to poll certain condition detectors which are configured to detect image quality problems. The resulting signals from the results of the poll can be processed by the controller 104 (under control of a diagnostic routine, such as routine 412 of FIG. 3) to more specifically identify the cause of the image quality problem. The controller 104 can then transmit a more narrowly defined information request (for example, in the form of another XML document) to the information network 70, focusing on the most likely cause or causes of the image quality problem. In another example, if a user registers his imaging apparatus with a service bureau, then part of the service provided by the service bureau can be periodic polling of the condition detectors (using information retrieval program 116 running in the virtual machine 114) to monitor the condition of the imaging apparatus. When a condition arises which needs to be brought to the attention of the user, then information to this effect can be transmitted to the imaging apparatus and printed or displayed for the benefit of the user.

Although the various components depicted in FIG. 2 are shown as being located either within or outside of the imaging apparatus 100, there is no requirement that this be the case. Accordingly, one embodiment of the present invention includes a system to retrieve information pertaining to an imaging apparatus (such as imaging apparatus 100 of FIG. 1). The system includes an imaging apparatus (100 of FIG. 1, for example) comprising an information retrieval signal generator configured to generate an information retrieval signal. As described above, the information retrieval signal generator can take the form of the user input device 130 of FIG. 2, as well as the condition detectors (142 and 144 of FIG. 2, and 202, 204, 206, 208, 210 and 212 of FIG. 7). The system further includes a communication device (60, FIGS. 1 and 2) which is connectable to an information network (70, FIGS. 1 and 2). The system includes a processor (102, FIG. 1, and/or 104, FIG. 2) configured to execute a series of computer executable instructions, and a memory device (110, FIG. 2) containing an information retrieval program (116, FIGS. 2 and 3). As described above, the information retrieval program 116 comprises a series of computer executable instructions to detect the information retrieval signal and, in response thereto, to retrieve from the information network 70, via the communication device 60, information pertaining to the imaging apparatus 100. Thus, the controller (102, FIG. 1, 104, FIG. 2), and the memory device (102, FIG. 1, 110, FIG. 2) can either be located within the imaging apparatus 100, or in a computer (such as workstations 50 and 55, FIG. 1) connected (directly or indirectly) to the imaging apparatus 100. Likewise, when the information retrieval signal generator is a user input device, the user input device can be the user interface 130 of FIG. 2, or it can be the user interface (such as a keyboard, a mouse, a display, speakers, a microphone, etc.) of one of the workstations 50 and 55, FIG. 1.

In accordance with the above description, another embodiment of the present invention is an imaging apparatus comprising a user display (such as display 132 of FIG. 2) configured to present to a user a plurality of retrievable information types (such as are depicted in FIG. 4, described above). Each information type is associated with information pertaining to the imaging apparatus. The imaging apparatus further includes a user input (such as 134, FIG. 2) to allow the user to select at least one of the retrievable information types. By selecting one of the information types, an associated information retrieval signal is generated. The imaging apparatus 100 further comprises a communication device (60, FIGS. 1 and 2) connectable to an information network (70, FIGS. 1 and 2). The imaging apparatus also has a controller (102, FIG. 1, 104, FIG. 2) configured to receive the information retrieval signal and, in response thereto, to use the communication device 60 to retrieve from the information network 70 the associated information pertaining to the imaging apparatus. This last function can be performed under the direction of an information retrieval program, such as program 116 of FIGS. 2 and 3, which can be contained within the memory device 110 (FIG. 2). Thus, in this embodiment the controller 104, the memory device 110, and the user display are resident within (or integral with) the imaging apparatus 100. Likewise, the communication device 60 can be resident within the imaging apparatus.

Yet another embodiment of the present invention provides for an imaging apparatus (such as imaging apparatus 100 of FIGS. 1 and 2) comprising: a condition detector (e.g., 142 and 144 of FIG. 2, and 202, 204, 206, 208, 210 and 212 of FIG. 7) configured to generate an information retrieval signal in response to a detected condition within the imaging apparatus, as described above. The imaging apparatus includes a communication device (60, FIGS. 1 and 2) connectable to an information network (70, FIGS. 1 and 2), and a controller (102, FIG. 1, 104, FIG. 2) configured to receive the information retrieval signal. In response to receiving the information retrieval signal, the controller is configured to use the communication device 60 to retrieve from the information network 70 information associated with the detected condition. This last function can be performed under the direction of an information retrieval program, such as program 116 of FIGS. 2 and 3, which can be contained within the memory device 110 (FIG. 2). Thus, in this embodiment the controller 104 and the memory device 110 are resident within the imaging apparatus 100 (FIG. 2). Likewise, the communication device 60 can be resident within the imaging apparatus 100.

The present invention also provides for a method of retrieving information pertaining to an imaging apparatus (such as imaging apparatus 100 of FIGS. 1 and 2). The method includes generating an information retrieval signal. This can be accomplished, for example, by the user input device 130 (FIG. 2), and as exemplarily described above with respect to FIG. 4. Generating the information retrieval signal can also be accomplished using a condition detector such as condition detectors 142 and 144 of FIG. 2, and 202, 204, 206, 208, 210 and 212 of FIG. 7, also described above. The method further includes using the information retrieval signal to initiate a communication session with an information network. This step can be accomplished, for example, by use of an information retrieval program (116, FIGS. 2 and 3), along with a communication device (e.g., 60, FIGS. 1 and 2), to retrieve information from an information network such as 70 of FIGS. 1 and 2. In the method, during the communication session, the information pertaining to the imaging apparatus is retrieved from the information network.

The method can further include printing the information retrieved from the information network. Examples of how this step can be performed were described above with respect to the information delivery menu 363 of FIG. 4, step 522 of flow chart 500 of FIG. 5, steps 618 through 624 of flow chart 600 (FIG. 6), and the “retrieved-file routing routine” 418 of FIG. 3.

The method can also include determining whether the imaging apparatus (e.g., 100, FIGS. 1 and 2) can print the information retrieved from the information network (such as was described above with respect to steps 618 through 624 of flow chart 600 (FIG. 6). When the imaging apparatus (e.g., 100) can print the retrieved information, the information is printed using the imaging apparatus. However, when the imaging apparatus (100) cannot print the retrieved information, the information is either displayed via a user display (132, FIG. 2) or is printed using another imaging apparatus (such as imaging apparatus 40 of FIG. 1).

The method can further comprise providing a menu of information types pertaining to the imaging apparatus, such as the menu system depicted in FIG. 4. The method then includes selecting one of the information types from the menu. In this case, the information retrieval signal is generated as a result of selecting one of the information types from the menu. Alternately, or in addition to the steps just described, the method can include detecting a predetermined condition within the imaging apparatus, for example by using a condition detector such as detectors 142 and 144 of FIG. 2, and 202, 204, 206, 208, 210 and 212 of FIG. 7. In this case, the information retrieval signal is generated as a result of detecting a predetermined condition within the imaging apparatus.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A system to retrieve information pertaining to an imaging apparatus, comprising:
an imaging apparatus comprising an information retrieval signal generator configured to generate an information retrieval signal;
a communication device connectable to an information network;
a processor configured to execute a series of computer executable instructions; and
a memory device containing an information retrieval program comprising a series of computer executable instructions to detect the information retrieval signal and, in response thereto, to retrieve from the information network, via the communication device, information pertaining to the imaging apparatus.

2. The system of claim 1, and wherein the information retrieval program further comprises a series of computer executable instructions to print the information.

3. The system of claim 1, and wherein the information retrieval program further comprises a series of computer executable instructions to store the information in the memory device.

4. The system of claim 1, and wherein the communication device, the processor, and the memory device are resident within the imaging apparatus.

5. The system of claim 4, and wherein the imaging apparatus further comprises a user input device comprising the information retrieval signal generator.

6. The system of claim 4, and wherein the imaging apparatus further comprises a condition detector comprising the information retrieval signal generator.

7. The system of claim 6, and wherein imaging apparatus is configured to image sheets of media, and further wherein the condition detector comprises a sheet counter configured to count sheets of media imaged by the imaging apparatus.

8. The system of claim 6, and wherein imaging apparatus is configured to image sheets of media using an imaging substance, and further wherein the condition detector is configured to detect a quantity of imaging substance used by the imaging apparatus to image sheets of media.

9. An imaging apparatus comprising:
a user display configured to present to a user a plurality of retrievable information types, each information type associated with information pertaining to the imaging apparatus;
a user input to allow the user to select at least one of the retrievable information types and to generate an associated information retrieval signal in response thereto;
a communication device connectable to an information network; and
a controller configured to receive the information retrieval signal and, in response thereto, to use the communication device to retrieve from the information network the associated information pertaining to the imaging apparatus.

10. The imaging apparatus of claim 9, and further comprising:
a memory device containing an information retrieval program; and
wherein the information retrieval program comprises a series of computer executable instructions configured to be executed by the processor to cause the processor to use the communication device to retrieve from the information network the associated information pertaining to the imaging apparatus.

11. The imaging apparatus of claim 9, and wherein the user input is configured to allow the user to selectively print or display the retrieved information.

12. The imaging apparatus of claim 9, and wherein the memory device contains a plurality of universal resource locators, and wherein each of the plurality of retrievable information types has an associated one of the universal resource locators.

13. The imaging apparatus of claim 9, and wherein the communication device is a web server.

14. An imaging apparatus comprising:
a condition detector configured to generate an information retrieval signal in response to a detected condition within the imaging apparatus;
a communication device connectable to an information network; and
a controller configured to receive the information retrieval signal and, in response thereto, to use the communication device to retrieve from the information network information associated with the detected condition.

15. The imaging apparatus of claim 14, and further comprising a plurality of condition detectors each configured to generate a unique information retrieval signal in response to an associated detected condition within the imaging apparatus, and wherein the controller is further configured to receive the unique information retrieval signal and, in response thereto, to use the communication device to retrieve from the information network information associated with the detected condition.

16. The imaging apparatus of claim 14, and wherein the controller is further configured to print the information associated with the detected condition.

17. The imaging apparatus of claim 16, and wherein the imaging apparatus is a first imaging apparatus, and the controller is further configured to print the information associated with the detected condition using the first imaging apparatus when the first imaging apparatus is capable of printing the information, and to direct the information to a second imaging apparatus for printing when the first imaging apparatus is incapable of printing the information.

18. The imaging apparatus of claim 14, and wherein the imaging apparatus further comprises a user display, and the controller is further configured to display the information associated with the detected condition using the user display.

19. A method of retrieving information pertaining to an imaging apparatus, comprising:
generating an information retrieval signal;
using the signal to initiate a communication session with an information network; and
during the communication session, retrieving information pertaining to the imaging apparatus from the information network.

20. The method of claim 19, and further comprising printing the information retrieved from the information network.

21. The method of claim 19, and further comprising determining whether the imaging apparatus can print the information retrieved from the information network and, when the imaging apparatus can print the information, printing the information, and when the imaging apparatus cannot print the information, selectively displaying the information via a user display, printing the information using another imaging apparatus, or saving the information to a memory location.

22. The method of claim 19, and further comprising:
providing a menu of information types pertaining to the imaging apparatus;
selecting one of the information types from the menu; and
wherein the information retrieval signal is generated as a result of selecting one of the information types from the menu.

23. The method of claim 19, and further comprising detecting a predetermined condition within the imaging apparatus, wherein the information retrieval signal is generated as a result of detecting a predetermined condition within the imaging apparatus.

24. The method of claim 23, and wherein the imaging apparatus is configured to image sheets of media, and the predetermined condition is a number of sheets of media imaged by the imaging apparatus.

25. The method of claim 23, and wherein the imaging apparatus is configured to generate images using imaging media, and the predetermined condition is a quantity of imaging media used by the imaging apparatus.
